(19) United States
(12) Patent Application Publication
(10) Pub. No.: US 2002/0099873 A1
(43) Pub. Date: Jul. 25, 2002

(54) Computer system status display panel and method of performing service

(76) Inventors: Vincent P. Hileman, Sunnyvale, CA (US); Timothy E. Mautz, San Francisco, CA (US); Denise Silverman, San Carlos, CA (US); Steven M. Wilson, San Jose, CA (US); Michael Sean White, San Jose, CA (US); Clifford B. Willis, Tracy, CA (US); Carl Meert, Sunnyvale, CA (US); David A. Rudy, Mountain View, CA (US)

Correspondence Address: Sun Microsystems, Inc., 901 San Antonio Road, MS UPAL1-521, Palo Alto, CA, 94303, US

(21) Appl. No.: 09/767,599

(22) Filed: Jan. 22, 2001

(51) Int. Cl. G06F 3/00

(52) U.S. Cl. 710/1

(57) ABSTRACT

A computer system and method of performing service thereto includes a centralized system status panel to identify and display the status of all field replaceable units (FRUs) within the computer system. The system uses electronic signaling such as LEDs on the system status panel to identify the presence and state of the FRUs within the system. The system further may use color differentiation to identify specific FRUs within the system. The system status panel may also include spatial locators to determine the location of the field replaceable units. Acronyms or symbols for the FRUs may further be included on the system status panel. Additionally, the computer system uses color differentiation on user accessible components and their interface features. Color differentiation on the user interface areas may allow a service technician to quickly identify where on the enclosures or individual component handling is possible or desirable. In addition, the computer system may use captive fasteners for the FRUs. Using color differentiation or other similar identification means, fasteners are identifiable by a hierarchy of use. Fasteners such as screws or pins which secure a component are distinguishable from those that secure the chassis of the computer system.

### BACKGROUND OF THE INVENTION

1. Field of the Invention

The present invention in general relates computer systems having field replaceable units, and more particularly, to a computer system incorporating color differentiation, spatial locators, status signaling and acronyms to identify, locate, and service field replaceable units.

2. Description of the Related Art

Distributed computer systems or computer networks are generally known. Computer networks typically comprise a plurality of personal computers, workstations, network appliances and other forms of data processing devices connected together for information exchange. At the heart of the computer network is one or more network servers, hereinafter referred to as “servers”. In most computer networks, the network server is responsible for managing the network, running applications, and administering documents or data generated at the attached data processing devices. With the growth of the internet and world wide web, data centers housing these computer systems are growing at an exponential rate. Space within the data center is at a premium, and significant amounts of hardware are condensed in that space. Examples of data centers may be internet service providers (ISPs), offering internet services for consumers and businesses, application service providers (ASPs), offering complex value added application hosting and access, network service providers offering network or internet service to the ISPs or large businesses, and full service providers (FSPs) offering more than one of the above services.

Demands placed on computer systems deployed in this environment include high performance, high availability and scalability, as well as being simple to operate and service. Internet service providers require continual availability and room for rapid growth of the system. Thus one requirement on computer systems including network servers is robust and swapable field replaceable units. Field replaceable units include peripheral devices typically designed to operate over industry standard interfaces such as PCI, SCSI, etc. For example, most modern desktop computers incorporate a local bus which is compliant with the Peripheral Component Interconnect (PCI) standard. The PCI bus is not truly a local bus (e.g. one which enables data transfer between the processor and memory/cache subsystem) but is instead an intermediate bus which is coupled to the processor by a PCI bridge/controller. Data can be transferred to devices on the PCI bus through the bridge controller, which typically buffers the data and allows the processor to perform other tasks while the data is transferred to the target device at the most efficient rate possible.

Compact PCI or cPCI is another industry standard which is related to PCI. Compact PCI is actually a combination of several well developed technologies including PCI bus technology, Eurocard mechanical technology (e.g. As used in VME bus systems), and pin and socket connector technology. The combination of these technologies results in a rugged reliable package for PCI devices.

The compact PCI standard also provides for several levels of hot swapping. Hot swapping refers to installing or removing devices from a computer while the computer is operating. Hot swapping is useful because it allows components to be replaced or upgraded without necessitating any downtime in the system. This feature is particularly important in applications such as network servers, routers, voice mail servers and other systems which must be online all of the time. Details of the compact PCI and hot swap standards may be found at cPCI PICMG 2.0 R2.1, R1.0 Hot Swap Specification.

Still other industry standard interfaces include SCSI or ATM for disk drives and/or other removable media devices. Thus, a server system board such as midplane or backplane, may include connectors for receiving SCSI or ATA mass storage devices, and external cards such as network interface cards. Other expansion slots may be provided on the server system board such as PCI (peripheral component interconnect) and cPCI (compact PCI).

However, as the type and number of peripheral devices, expansion cards, I/O interface cards, and FRUs within a computer system complexity in servicing these systems also increases. Technicians unfamiliar with a particular system may have difficulty identifying a failed component within the computer system. Even if a system message indicates the failed component, it may be difficult to locate the component within the system. Lastly, even if the component is identified and located, device support personnel may not know how to remove or replace that component.

Sometimes these systems operate in a lights out environment, and a technician is sent in to fix a failed component which was identified at a remote monitoring location. Technicians and support personnel in this environment often rely heavily on documentation to service the system. This can be time consuming and costly, increasing system down time when the failure is not quickly addressed or incorrectly addressed.

Thus, there is a need in the art to address the aforementioned problems by providing a computer system having a clear, well defined and intuitive component identification system and method of servicing.

### SUMMARY OF THE INVENTION

To overcome the limitations described above, and to overcome other limitations that will become apparent upon reading and understanding the present specification, disclosed is a computer system having a centralized, unambiguous and understandable display of the status and location of the system field replaceable units (FRUs). The present specification further describes a method for identifying, locating and servicing FRUs within the computer system.

Briefly stated, one embodiment of a computer system according to the present invention includes a centralized system status panel to identify and display the status of all field replaceable units (FRUs) within the computer system. One embodiment of the system may use electronic indicators on the system status panel to identify the presence and state of the FRUs within the system. An embodiment of the computer system may further use color differentiation to identify specific FRUs within the system. The system status panel may further include spatial locators to determine the location of the field replaceable units. Acronyms and/or symbols for the FRUs may further be included on the system status panel.

Still another embodiment of the present invention uses color differentiation on user accessible components throughout the system. A consistent color is implemented throughout the system on user interaction points such as handles, levers and ejectors. Color differentiation on the user interface areas simplifies the visual search for user interaction points, allows the user to avoid contact with areas or parts that will not produce desired results, and may allow a service technician to quickly identify where on the enclosures or individual component handling is possible or desirable.

Still another embodiment of the present invention includes color differentiation on system components and their fasteners thereby creating a hierarchy of user actions. For example the fasteners that secure a component to the chassis are one color while fasteners that attach components are another. In instances where fasteners are closely co-located, a technician can more readily determine which fasteners need to be acted upon to secure or remove a FRU.

A method of servicing the computer system described herein may comprise the steps of detecting a failed component from indicators on a central display panel, using spatial locators to convey the location of the component within the computer system, and using color differentiation on user accessible components to remove and replace the failed component. Another embodiment of a method according to the present invention may include detecting an empty component slot in a computer system from the indicators on a centralized display panel; using spatial locators to find the location of the empty slot; and lastly using color differentiation on user accessible components to install a component into the slot.

One advantage of the present invention is the improved serviceability, which will be described in more detail in the following detailed description.

### BRIEF DESCRIPTION OF THE DRAWINGS

Referring now to the drawings, in which like reference numerals represent corresponding parts throughout:

FIG. 1 is a perspective view of an exemplary computer system according to the present invention;

FIG. 2 is a perspective view of one embodiment of computer system according to the present invention;

FIG. 3 is an exploded view of computer system shown in FIG. 2, showing the location of various field replaceable units;

FIG. 4 is a perspective view of another embodiment of the computer system according to the present invention;

FIG. 5 is an exploded view of the computer system shown in FIG. 4, showing the location of various field replaceable units;

FIG. 6A illustrates one embodiment of a system status panel; FIG. 6B illustrates one embodiment of an interior display panel;

FIG. 7 is another embodiment of a system status panel;

FIG. 8 is a side perspective view of a computer system showing some examples of user interface areas;

FIG. 9 is partial front view of a computer system showing examples of user interface areas; and

FIG. 10 is an enlarged front view of a computer system of the present invention showing one example of hierarchical differentiated fasteners.

### DETAILED DESCRIPTION OF THE PREFERRED EMBODIMENT

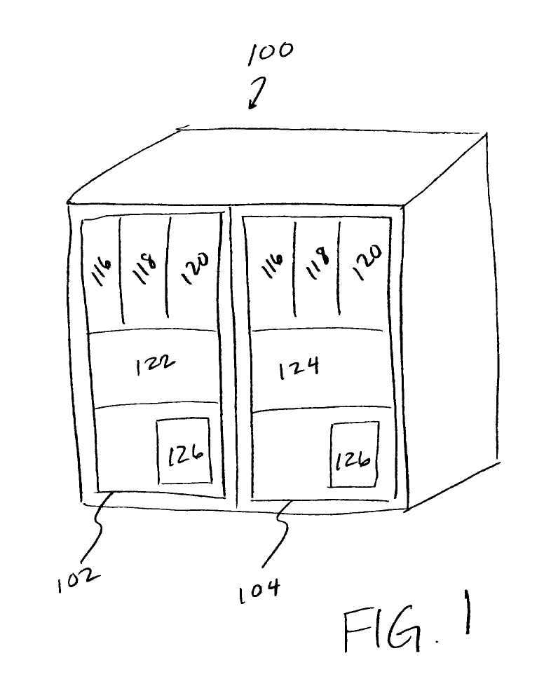

FIG. 1, is a schematic diagram of an exemplary computer system 100 which is in one embodiment a rack mounted server. Server 100 comprises a chassis which houses one or more individual computer systems 102, 104 each housed in a subchassis. Individual computer systems 102, 104 further include power supply 126, expansion card slots 116, 118, 120 and system status display panels 122, 124. Computer system 100 may be a network server located in a data center being remotely monitored and locally serviced. Although this is one exemplary embodiment, it is understood that any computer system having field replaceable units is within the spirit and scope of the present invention.

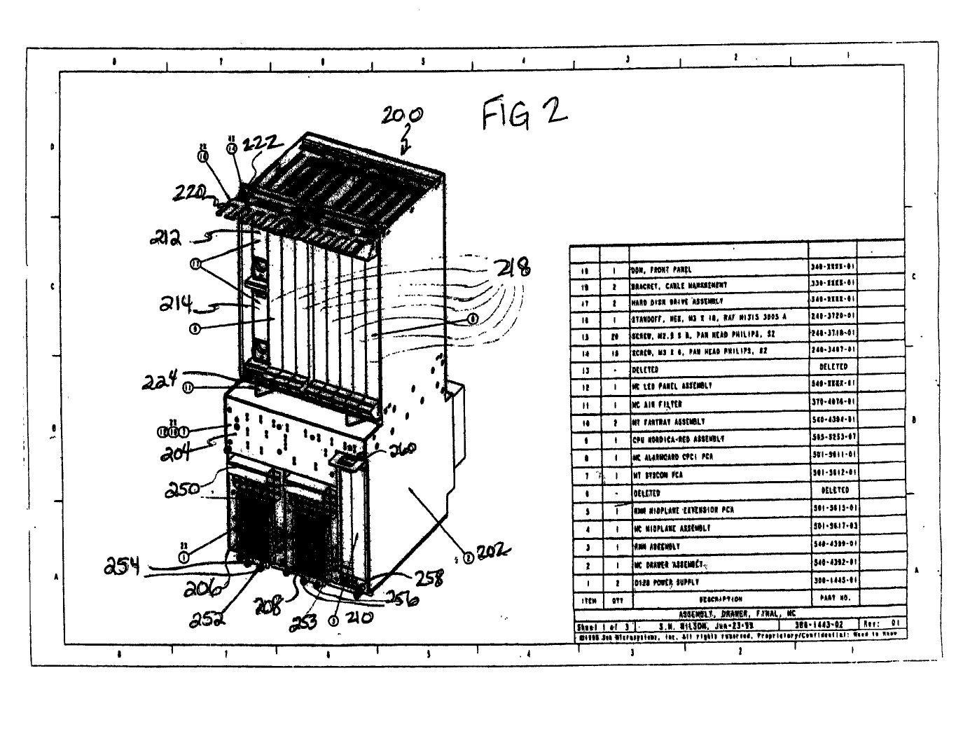

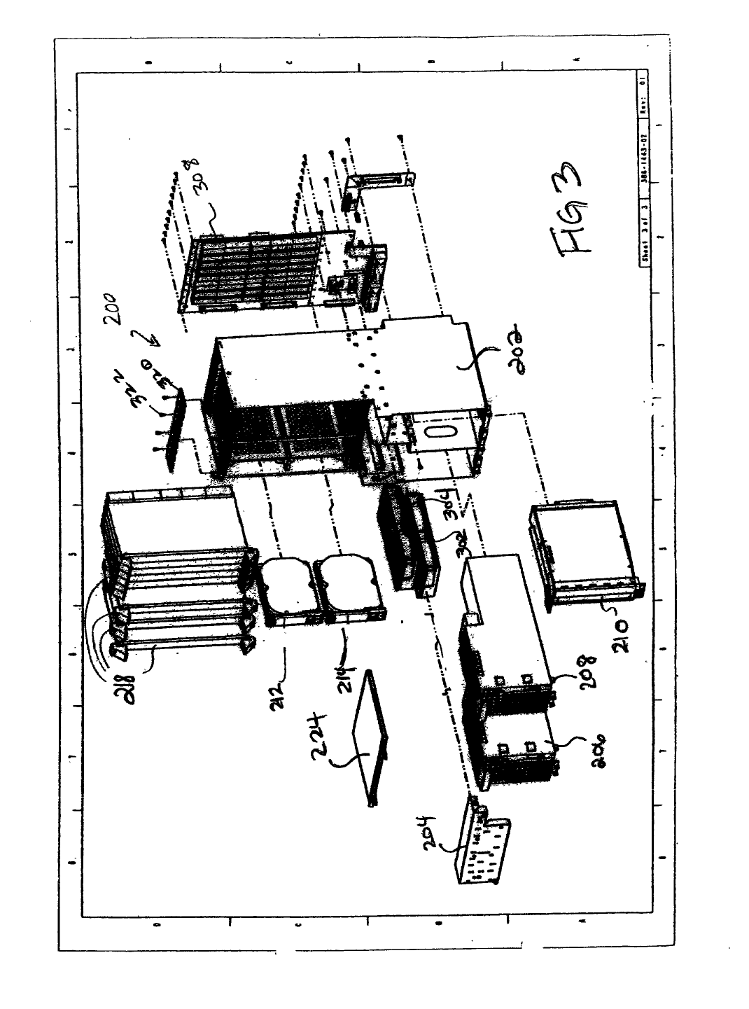

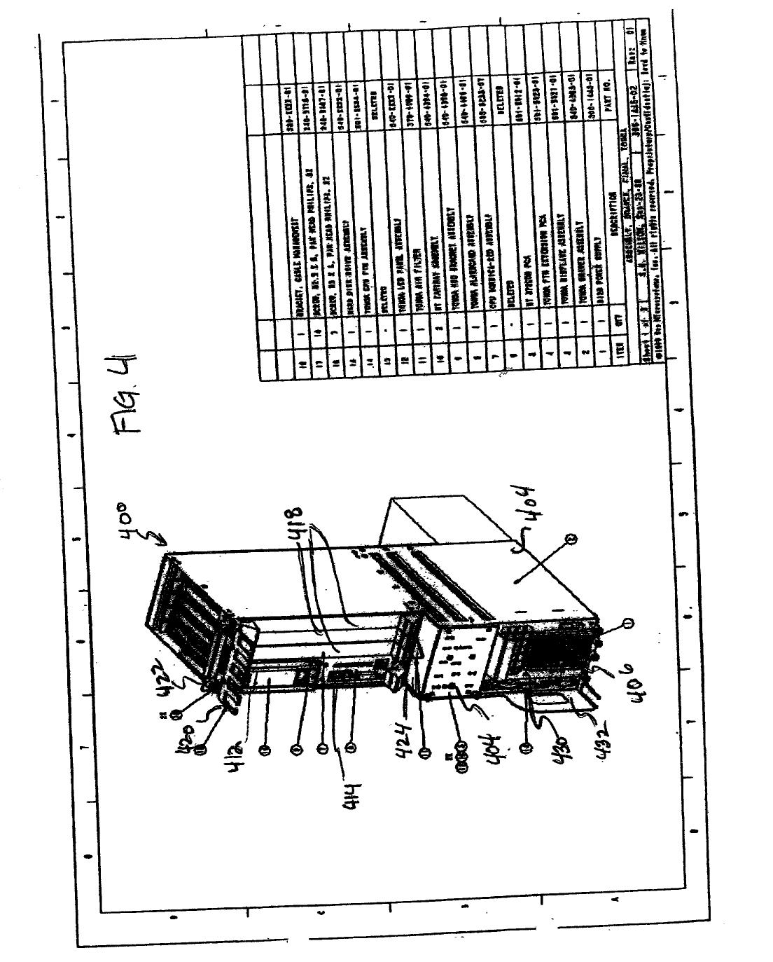

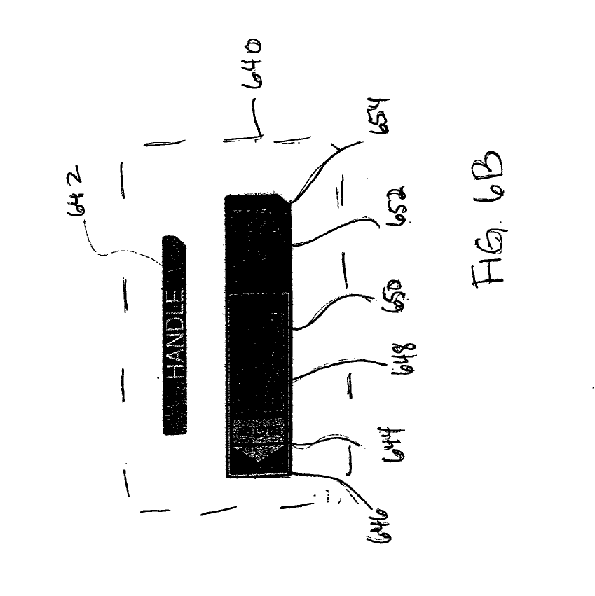

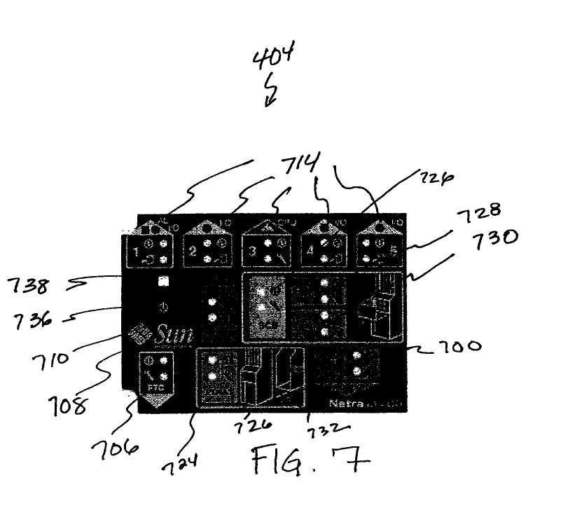

FIG. 2 shows one embodiment of of a computer system having field replaceable units. Computer system 200 is comprised of a drawer assembly or subchassis 202, which is removably installed within a chassis (not shown). Computer system 200 further includes a system display panel 204 which itself is a field replaceable unit, and will further be described below in connection with FIGS. 6 and 7. Behind the system display panel 204 are located two fan trays and system control board which are not shown, but will be shown in connection with FIG. 3 Computer system 200 has two power supplies represented by 206 and 208. Each of the power supplies 206 and 208 are field replaceable units. Power supplies may be for example DC power supplies. Computer system 200 may also comprise one or more mass storage devices. For example, system may include a removable media module 210, and one or more hard disk drive assemblies, 212 and 214. One or more expansion slots 218 which all are adapted to support field replaceable expansion cards. Examples of expansion cards include network interface controllers, such as ethernet and fast ethernet, system alarm cards, and CPU cards. These cards may all be compliant with the Compact PCI standard and may be hot swappable. An exemplary system such as the one shown in FIG. 2 may be the Netra® ct800 by Sun Microsystems®. An exemplary system may be certified to meet or exceed the Network Equipment Building System (NEBS) Level 3 standard as defined by Bellcore at (add in this cite ) and ETSI at (add in this cite).

FIG. 3 shows an exploded of the computer system 200 shown in FIG. 2. As seen in with FIG. 3, all the components within the subchassis 202 are field replaceable units that connect in the system through the midplane (or backplane) 308. Transition cards (not shown) are installed into the backside of midplane 308. As indicated above, the location and status of these components is found on a centralized system display panel 204. FIG. 3 further shows that the various field replaceable units plug into midplane 308. FIG. 3 further shows a pair of fan trays 302 and 304, cable routing bracket 320 and chassis attachment screws 322.

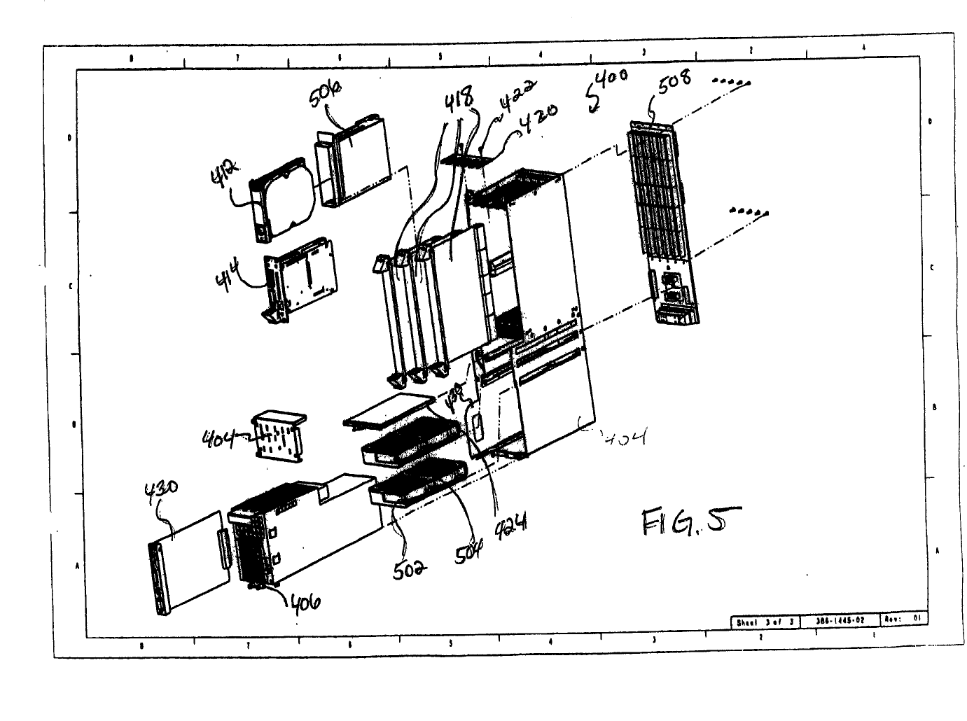

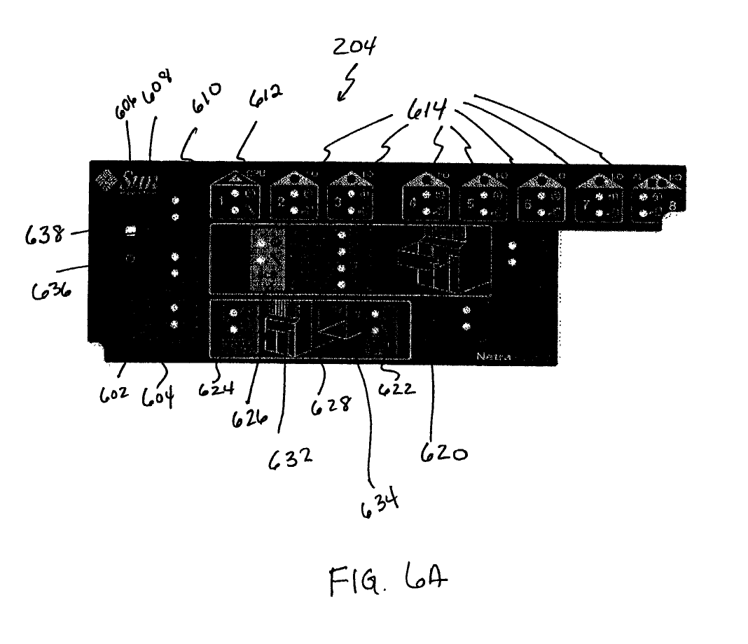

FIG. 4 illustrates a second example of a computer system according to the present invention. Computer system 400 is comprised of a drawer assembly 402, which is removably installed within a chassis (not shown). Computer system 400 further includes a system display panel 404 which itself is a field replaceable unit, and will further be described below in connection with FIG. 7. Behind the system display panel 404 are located two fan trays and system control board which are not shown, but will be shown in connection with FIG. 5 Computer system 400 has a power supply represented by 406. The power supply 406 is a field replaceable unit and may be, for example, a DC power supply. Computer system 400 may also comprise one or more mass storage devices such as a disk drive assembly 412. One or more expansion slots 418 which all are adapted to support field replaceable expansion cards. Examples of expansion cards include network interface controllers such as ethernet and fast ethernet, system alarm cards, and CPU cards. These cards may all be compliant with the Compact PCI standard. An exemplary system such as the one shown in FIG. 2 may be the Netra® ct400 by Sun Microsystems®. An exemplary system may be certified to meet or exceed the Network Equipment Building System (NEBS) Level 3 standard as defined by Bellcore Bellcore and ETSI.

FIG. 5 is an exploded view of the computer system shown in FIG. 4. As seen in connection with FIG. 5, all the components in the system 400 are field replaceable units. As indicated above, the location and status of these components is found on centralized system display panel 404. FIG. 5 further shows that the various field replaceable units plug into midplane 508. FIG. 5 further shows mount bracket 506 which is selectively used on an expansion slot to support disk drive 412.

FIG. 6A is an enlarged view, front view of one example of the system status display panel 204 which is shown in connection with the computer system of FIG. 2. System status display panel 204 comprises guide label 600 which include spatial locators for the field replaceable components in the computer system. HDD indicator 606 and HDD indicator 608 topped by HDD arrow 610 indicate the location HDD devices within the system. Arrow 610 indicates that the HDD devices may be found above the indicator labels 606 and 608 within the computer system 200. On the HDD indicators 606 and 608 (as with the other indicators that will be described throughout) each further comprise electronic signaling such as a pair of LEDs. In general, the pair of LEDs are used to indicate the presence of a device, the upper one designated by a lightning bolt, and the status/serviceability of the device, the lower one referenced by a wrench or box with arrow. These two LEDs differ in color and the operation of each within the system will be further described below. It is understood that the color, icons and spatial location of these LEDs on the display panel is one embodiment of the present invention and changes made thereto may be contemplated without departing from the spirit and scope of the present invention.

Continuing still with reference to FIG. 6A, along the upper edge of guide label, are CPU indicator 612, and a plurality of I/O expansion card indicators 614. Consistent with the operation of the HDD indicators 606, 608, each of the I/O indicators 614 comprise an arrow and pair of LEDs. The arrow generally references where the device may be found in the computer system, and the LEDs indicate status and serviceability. The system status display panel further includes RMM indicator 616 and arrow 618, which indicates the location and status of RMM device 210. PSU indicators 622 and 624 indicate the location and status of power supply units 206 and 208 respectively.

Still with reference to FIG. 6A, the system status display panel 204 further comprises system control board indicator 626, fan indicator 628 and fan indicator 630. While all of these indicators have a pair of LEDs, none have an associated arrow. The elimination of the arrow and representation of the indicators clustered in the separate box in the center of the label, along with the wrench icon associated with the lower LED, indicate that the device sits behind the panel 204, within the interior of the computer system 200, and the panel 204 which itself is an FRU needs to be removed the access the device. This is further indicated by serviceability FIG. 620 which indicates how to remove the panel 204.

System display panel 204 further includes power distribution unit indicators 622 and 624. Similar to the indicators discussed above, these also include a pair of LEDs but no associated arrow. This indicates these power distribution units are also interior to the computer system (as shown clustered in a second box to separate them from the other components) and that the subchassis 202 needs to be removed before they can be accessed. The second system serviceability FIG. 628 further emphasizes how to service. Lastly knob 636 is the computer system on/off switch, and indicator 638 is computer system power indicator.

As can be understood from the description above in connection with FIG. 6A, a representation of the location of all of the system components and their status are combined into a centralized location, thereby improving the serviceability of the entire computer system.

Continuing now with reference to FIG. 6B, which is a front view of a second system status display panel 640. Second system status display panel 640 may be found directly behind system status display panel 204, and further indicates the location of those devices that were displayed on the system status display panel as interior to the system. Thus, interior RMM indicator 654 and RMM arrow 652 indicate the location of the RMM, fan1 indicator 648 and fan2 indicator 650 indicate the location of the fans, and interior SCB indicator 644 and arrow 646 indicate the location of the system controller board.

As described above in connection with FIG. 6A, each indicator on the system status display panel 204 comprises a pair of LEDs. One example of how the system status panel and these LEDs may operate is described herein. There are two color LEDs per component in the computer system. Each component has a green and amber LED. It is understood that the color of the LEDs may vary and changes made thereto may be implemented. In this embodiment, the green LED is tri-state, thus it can be on, off or flashing. The amber LED is bi-state, meaning it can be on or off. In the present example of the invention, the green LED is the upper LED on the indicators, while the amber LED is the lower LED.

The green LED is used consistently across the components within the system. If the state is OFF, this means that no component is present, or a component has not been detected. A BLINK status means a component has been inserted; either it is being configured or unconfigured. ON status means that the component is installed and in use. The OFF to BLINK transition may be controlled by hardware. It is the indicator that the insertion of the component was detected and it is now present in the computer system. The BLINK to ON transition may be controlled by software. This is the indicator that the component insertion has been detected by the software and the component is being configured for use by the system. Lastly, the ON to BLINK transition may also be controlled by the software. This typically is the result of a user action, most notably a “request to disconnect” the component from the system.

The amber LED may be entirely under the control of the software in the computer system. The amber LED has two meanings, based on the type of component. For accessible components (such as the RMM or HDDS), the amber LED is an “OK to remove” indicator. For the secondary-access components (such as the fans or PDUs), the amber LED is a “fault” indicator.

Accessible components can be inserted and removed directly from the front panel. Non-accessible components require access into the machine, for example fans which can only be removed after the LED panel itself has been removed, and the PDUs. For accessible components, the “OK to remove” status operates as follows. For an OFF state, the component is not OK to remove. Removal of a component in this state may adversely impact the availability or “uptime” of the computer system. For an ON state, the component is OK to remove. This component may be safely removed without any adverse affects . The system may continue to run normally during the removal and re-insertion of the component.

For non-accessible components, the “fault” indicator status operates as follows. If the LED is OFF, the component is operating normally. For an ON state, the component has failed and should be replaced. Replacement steps of a non-accessible component involve moving other components first. The movement of those components is the signal to the software operating in the computer system that an impending movement interior to the system may occur.

FIG. 7 is an enlarged front view of another example of the system status display panel 404 which is shown in connection with the computer system of FIG. 4. LED display panel 404 comprises guide label 400. HDD indicator 708 topped by HDD arrow 710 indicate the location HDD device 412 within the system. Arrow 710 indicates that the HDD device 412 may be found above the indicator label 700 within the computer system 400. The LEDs on HDD indicators 708 (as with the other indicators that will be described throughout) operate as described above in connection with FIGS. 6A and 6B.

Continuing still with reference to FIG. 7, along the upper edge, are a plurality of I/O expansion card indicators 714. Consistent with the operation of the I/O indicators described in connection with FIG. 6A, each of the I/O indicators 714 comprise an arrow and pair of LEDs. The arrow generally references where the device may be found in the computer system, and the LEDs indicate status and serviceability. PSU indicators 702 and arrow 704 indicate the location and status of power supply unit 406. System display panel 404 further includes FTC indicator 706 which indicates the status of the system FTC.

Still with reference to FIG. 7, the system status display panel 404 further comprises system control board indicator 726, fan indicator 728 and fan indicator 730. While all of these indicators have a pair of LEDs, none have an associated arrow. The elimination of the arrow and representation of a single square, associated with the lower LED indicate that the device sits behind the panel 404, interior to the computer system 200, and the panel 404 which itself is an FRU needs to be removed the access the device. This is further indicated by serviceability FIG. 720 which indicates how to remove the panel 704. The wrench icon means that there is an associated fault or some sort of service needs to be performed on a component in the server.

System display panel 404 further includes power distribution unit indicator 724. Similar to the indicators discussed above, each of these indicators also include a pair of LEDs but no associated arrow. This indicates the units are interior to the computer system and that the power modules below need to be removed before they can be accessed. The second system serviceability FIG. 732 further emphasizes the approach. Lastly knob 736 is the computer system on/off switch, and indicator 738 is an opening for a power LED. This LED will illuminate when the system is receiving full power and will be off when the system is in standby mode.

Each of the indicators discussed above in connection with FIGS. 6A, 6B and 7 may have its own distinct color, and a similar color demarcation may be found on the individual component or component location on the front surface of the computer system. This further assists in a quick visual identification of each of the field replaceable units within the system.

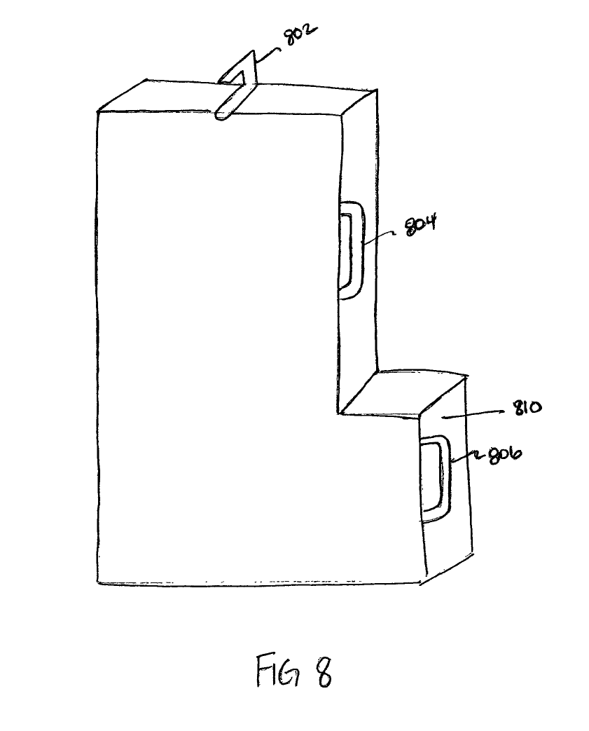

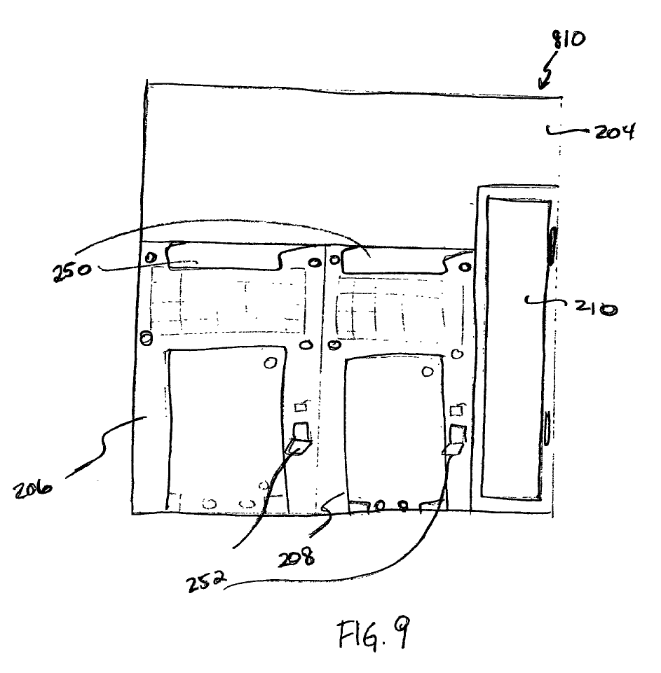

Turning now to FIGS. 8 and 9, the color distinction of user interfaces is shown and described. Color is used to differentiate user accessible components and their interface areas. In one example, parts on the computer system 100 that require human interaction are powder coated, molded, painted or otherwise formed from one color, which is distinct from the color of the computer system 100 itself (for example purple). FIG. 8, shows an example of color differentiation used on computer system components. Bucket handle 806 (or drawer carry handle) is powder coated from this color, and provides a secure place to carry either a loaded or empty drawer. Lower handles 802 and 804 (drawer removal handles) provide access to release the drawer from within the chassis. Each of these handles, for example, may be coated in the color purple.

FIG. 9 further illustrates the use of color distinction of user interface points. FIG. 9 is a front view of the lower portion of the computer system shown in FIG. 2. Here, power supply handles 250, and mechanical interlocks 252 which need to be contacted to remove/replace the power supply may also be molded in the same color as the handles shown in connection with FIG. 8.

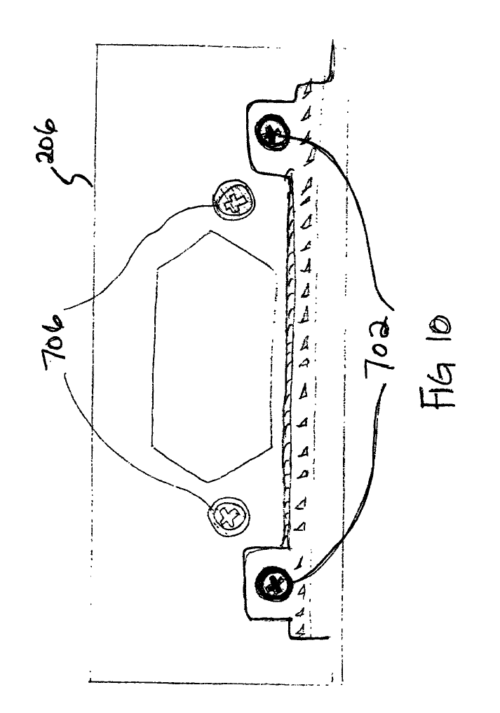

Referring now to FIG. 10, the captive fasteners according to the present invention will now be described. In this embodiment of the present invention, color differentiation is used to distinguish between captive fasteners which secure the computer system chassis and captive fasteners used in connection with the field replaceable units, thereby creating a hierarchy of use that allows a user to clearly make this distinction when servicing the computer system. In one embodiment of a computer system having a very small form factor, fasteners securing FRUs may be closely located to those securing the computer system chassis, making distinctions difficult for a technician who may be servicing field replaceable units.

With reference to FIG, 10, black may be used for chassis fasteners 702. Silver may be used for field replaceable unit fasteners 706. The field replaceable unit shown in this example is a power supply unit 206. It is understood that any field replaceable units described in this specification, or any others that may be contemplated for the computer system, may be represented in a similar fashion. Although black and silver are described herein, other colors may be substituted. In addition, although a two tiered system is described, this could further be implemented in a three tier system or higher. For example, the field replaceable units described in connection with FIG. 6 that sit behind the system status display panel, might use fasteners of a third color, differentiating those from the color of the fasteners to the field replaceable units readily visible. Chassis fasteners 702 and FRU fasteners 706 may be, for example, screws, pins, clips, latches or any other type of mechanical apparatus suitable for securing computer components to one another.

The foregoing description of the preferred embodiment has been presented for the purposes of illustration and description. It is not intended to be exhaustive or to limit the invention to the precise form disclosed. Many modifications and variations are possible in light of the above teachings. It is intended that the scope of the invention be limited not with this detailed description, but rather by the claims appended hereto.

What is claimed is:

1. A computer system comprising:
a central processing unit;
a main memory;
at least one field replaceable unit; and
a system status display panel comprising at least on component identifier said component identifier for indicating the location of the at least one field replaceable unit.

2. The computer system according to claim 1, wherein the component identifier comprises a pair of status signals for said at least one field replaceable unit.

3. The computer system according to claim 2, wherein said pair of status signals are LEDS.

4. The computer system according to claim 3, wherein one the said pair of LEDs is tri-state, said states being one of the group consisting of off-no component present; on-component present and ready to use, and blink-field replaceable unit present and being configured or unconfigured.

5. The computer system according to claim 1, wherein the system status display panel is field replaceable.

6. The computer system according to claim 1, wherein the component identifier further comprises a directional indicator to the at least one field replaceable unit.

7. The computer system according to claim 1, wherein the at least one component identifier has a unique color assignment.

8. A computer system status display panel comprising:
a plurality of component indicators; and
a pair of electronic signals associated with each of the plurality of component indicators.

9. The computer system status display panel of claim 8, further comprising a directional locator associated with a subset of said component indicators.

10. The computer system status display panel of claim 8, wherein the plurality of component indicators have unique color assignments for the type of components they indicate.

11. The computer system according to claim 8, wherein said pair of status signals are LEDs.

12. The computer system according to claim 11, wherein said LEDs each has a unique color.

13. The computer system according to claim 11, wherein one of said LEDs represents the presence of a component, and the second LED represents a s tatus of said component.

14. A computer system comprising:
a chassis housing a computer system comprising a main memory, central processing unit and at least one field replaceable unit; and
at least one handle for installing or removing said computer system in said chassis, said handle being a distinct color different than the color of said computer system.

15. The computer system according to claim 14, wherein said handle is a drawer carry handle.

16. The computer system according to claim 14 wherein said handle is a drawer removal handle.

17. The computer system according to claim 14, further comprising a field replaceable unit handle for installing or removing said at least one field replaceable unit in said computer system.

18. The computer system according to claim 17, wherein said field replaceable unit handle is the same color as said at least one handle.

19. The computer system according to claim according to claim 14, further comprising at least one latch on said chassis, said latch being the same color of the at least one handle.

20. The computer system according to claim 14, comprising at least one latch on said field replaceable unit, said latch being the same color of the at least one handle.

21. The computer system according to claim 14, comprising at least one switch on said field replaceable unit, said switch being the same color of the at least one handle.

22. A computer system comprising:
a chassis housing a computer system comprising a main memory, central processing unit and; at least one field replaceable unit;
at least one chassis fastener for installing or removing said computer system in said chassis; and
at least one field replaceable unit fastener for installing or removing a field replaceable unit in the computer system, wherein the at least one chassis fastener is a different color than said at least one field replaceable unit fastener.

23. The computer system of claim 22, wherein said at least one chassis fastener and said at least on field replaceable unit fastener is a screw.

24. The computer system of claim 22, wherein said at least one chassis fastener and said at least on field replaceable unit fastener is a pin.
